(19) United States
(12) Patent Application Publication
(10) Pub. No.: US 2014/0205973 A1
(43) Pub. Date: Jul. 24, 2014

(54) Interactive genealogical charts

(71) Applicant: Kinpoint, Inc., Salem, UT (US)

(72) Inventors: Charles D. Knutson, Salem, UT (US); Daniel Zappala, Cedar Hills, UT (US); Justin C. York, Spanish Fork, UT (US); Robert A. Brown, Provo, UT (US); Steven C. Nay, American Fork, UT (US); Justin T. Seliger, Bentonville, AR (US); Scott M. Erickson, Princeton, NJ (US); Derrick J. Brinton, Lafayette, CA (US)

(73) Assignee: Kinpoint, Inc., Salem, UT (US)

(21) Appl. No.: 14/162,104

(22) Filed: Jan. 23, 2014

Related U.S. Application Data
(60) Provisional application No. 61/849,380, filed on Jan. 24, 2013.

(51) Int. Cl. G09B 19/00

(52) U.S. Cl. CPC G09B 19/0046
USPC 434/154

(57) ABSTRACT

Presenting genealogical information. A method includes displaying a representation of a first individual. The method further includes displaying a ring chart for the first individual. The ring chart includes elements representing individuals with familial relationships to the first individual in a ring chart fashion. Displaying a ring chart includes displaying the ring chart with visual coding. The visual coding indicates a level of completeness of research done for individuals represented in the ring chart.

### CROSS-REFERENCE TO RELATED APPLICATIONS

This application claims the benefit of U.S. Provisional application No. 61/849,380 filed Jan. 24, 2013, titled “THE TWENTY MINUTE GENEALOGIST”, which is incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc. Computing systems can be used to perform so called genealogical research or family history research where individuals seek out information about their (or others) ancestors, descendants, and related family members. As used herein, the term “ancestor” refers to one or more family members (including ancestors, descendants, parents, children, siblings, or other relatives, whether closely or distantly related) for which research might be conducted. Computer systems can be used to create pedigree charts and to navigate pedigree charts to document and find information about ancestors.

Research suggests that those who believe it is important to work on their genealogy do almost no work with any regularity, primarily because they don't know how to start or because they perceive that it takes too much time. Effective navigation of family records helps people to quickly determine which of their ancestors they should work on, and the nature of the work that needs to be done for that ancestor. Navigation of family records is traditionally performed using pedigree charts, which graph ancestors of an individual and often include additional information such as birthdates, death dates, baptism dates, marriage dates, etc., and family group sheets which are database-like records listing members of a nuclear family including a father, a mother, and known children along with significant event dates.

While these tools can be effective for viewing small parts of a family tree or members of an individual family, they fail to reduce the complexity of navigating a large, exponentially expanding graph structure (i.e., a pedigree chart). Traversing one's pedigree by navigating a few generations at a time is not unlike admiring the Grand Canyon while gazing through a straw—it is very difficult to acquire and maintain the big picture. In more pedestrian terms, once a researcher has clicked through several generations of a pedigree, visited children, or moved to a cousin, it can be difficult to locate where they are in the graph, even within just a few generations. More importantly, traditional navigational metaphors provide at best small clues or hints as to work that needs to be done, and almost no sense of completion for work once finished. Traditional navigational metaphors also fail to accommodate or facilitate a user's individualized sense of purpose or quest, and a user's individualized perspective on what constitutes the completion of a particular task for a given ancestor.

For amateur genealogists with precious little time—maybe only an hour each week to dedicate to family history research—they typically spend as much or more time remembering why and what they were doing than they do actually searching for their ancestors. As time between sessions rises and available time shrinks, they reach a point where all time spent is context switching with no actual work accomplished, referred to herein as “thrashing”. In particular, a significant level of immersion is required by family history researchers to maintain a current and accurate mental model of research objectives, prior accomplishments, and upcoming goals or quests. When time spent falls below this threshold, the researcher's mental model suffers, and significant time must be invested to restore the researcher's mental model before she can resume productive research.

Needless to say, amateur genealogists who suffer through multiple episodes of thrashing soon find their motivation for family history research waning. Even for experienced genealogical researchers, a layoff of as little as two weeks can require a researcher to invest considerable time reconstructing a mental model of their research space. Of course, for experienced researchers with significant time to spend, the cost of reconstructing a mental model is amortized across the ensuing multiple weeks of research immersion, and thus is viewed as a necessary evil. Unfortunately, the pool of experienced genealogical researchers with considerable time to spend each week is a very small set, perhaps as little as 1-3% of the population of those who claim to care about genealogy.

The subject matter claimed herein is not limited to embodiments that solve any disadvantages or that operate only in environments such as those described above. Rather, this background is only provided to illustrate one exemplary technology area where some embodiments described herein may be

### BRIEF SUMMARY

One embodiment illustrated herein includes a method that may be practiced in a computing environment. The method includes acts for presenting genealogical information. The method includes displaying a representation of a first individual. The method further includes displaying a ring chart for the first individual. The ring chart includes elements representing individuals with familial relationships to the first individual in a ring chart fashion. Displaying a ring chart includes displaying the ring chart with visual coding. The visual coding indicates a level of completeness of research done for individuals represented in the ring chart. The term “ring chart” as used herein includes representations, such as the popular “fan chart” or similar representations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a first example of a ring chart;

FIG. 1B illustrates a second example of a ring chart;

FIG. 2 illustrates a profile view user interface screen that provides detailed information for a particular ancestor;

FIG. 3 illustrates a suggestions view user interface screen that provides a list of suggested tasks associated with ancestors being researched;

FIG. 4 illustrates an example architecture that may be used to facilitate research; and

FIG. 5 illustrates a method of presenting genealogical information

### DETAILED DESCRIPTION

Effective context preservation enables a user to quickly jump into a genealogical quest, despite significant time lags between research sessions and lack of immersion time. While helpful hints, such as a list of research tasks or a set of bookmarks, may provide some assistance, alone they may not provide a sufficiently rich user experience to enable an amateur researcher with very little available time to retain sufficient context during infrequent forays into their ancestral tree.

Embodiments described herein may implement a genealogical tool that implements an innovative combination of effective navigational metaphors and/or context preservation methods to provide a rich experience. Embodiments may include one or more client-facing products such as a standalone application, a browser-based web application, a mobile device application, etc. Embodiments may, alternatively or additionally, include server infrastructure to facilitate the user experience.

Embodiments may implement techniques used in gamification of software design. The basic idea of gamification is to apply concepts from game design to non-game applications to make them more engaging.

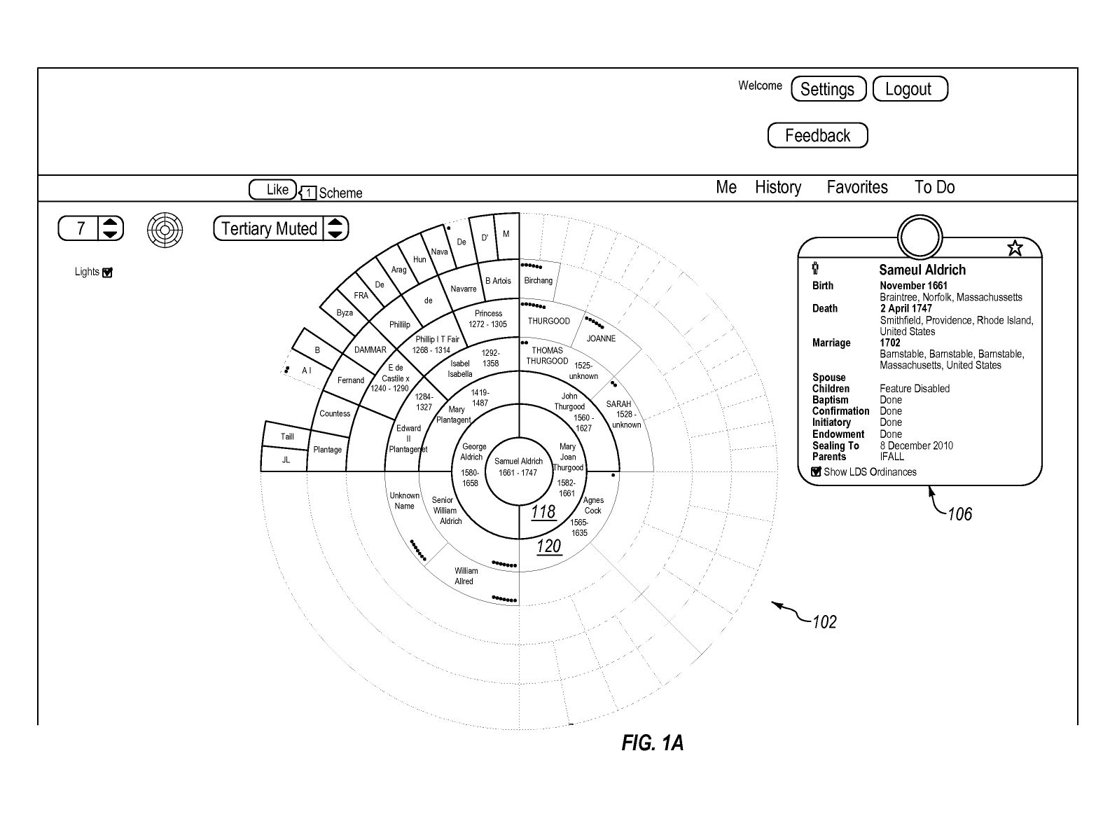

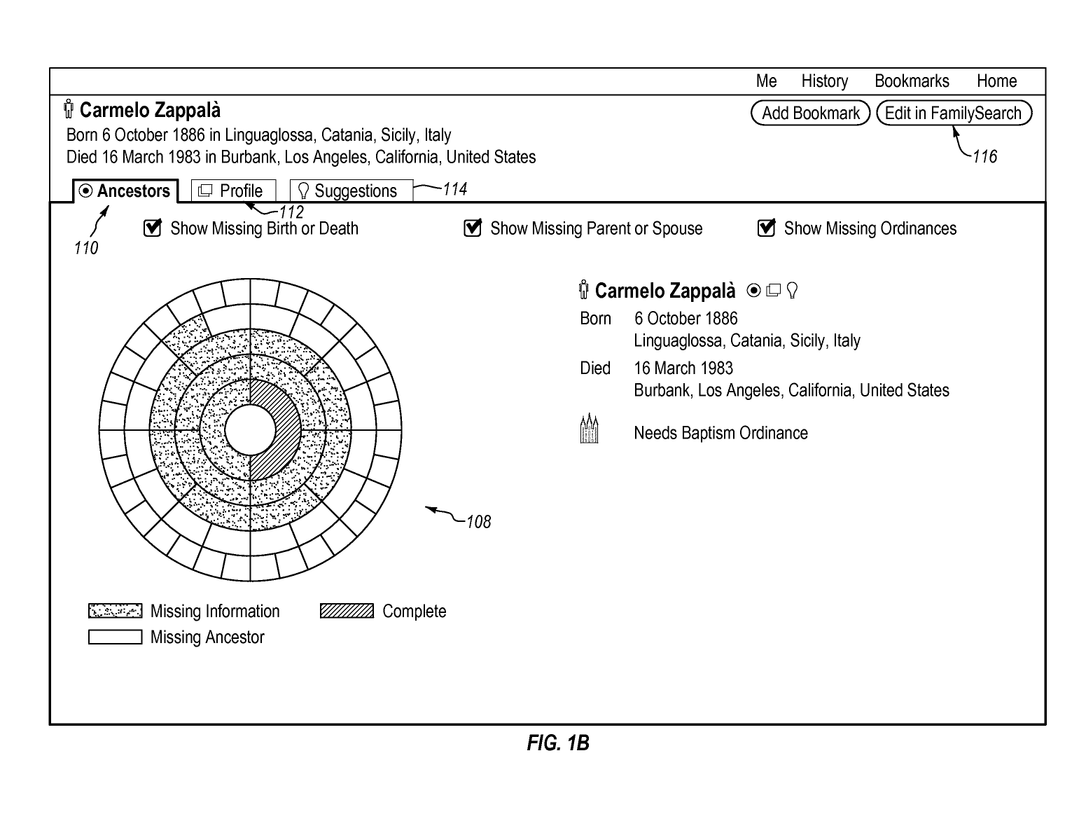

Embodiments may implement a “command center” metaphor in conjunction with a task or puzzle completion grid. Some embodiments may be used in conjunction with an underlying database system or service. For example, some embodiments may be used in conjunction with the FamilySearch ancestral search tool available from The Church of Jesus Christ of Latter-day Saints at familysearch.org. Embodiments may include a user interface to allow a user to authenticate to a service or database and to access the underlying data in the service or database. For example, embodiments may provide a pop-up window that allows a user to present FamilySearch credentials, which are then transmitted to the FamilySearch service and information for the user retrieved from the FamilySearch service. This information is then used to populate a user interface, such as user interface 100 illustrated in FIG. 1A. Embodiments may include a “skin” that allows customization of a user interface in accordance with the user's preferences and sense of aesthetics. Some embodiments may default to the user himself or herself in the center node 104 of ring chart 102. However, FIG. 1A illustrates an example where an ancestor individual is selected and dragged to the center node 104 of the ring chart 102. A ring chart employs a technique for displaying genealogical information in a compact form by displaying an individual of interest at the center of the ring chart and displaying ancestors of the individual at locations located progressively distant from the center of the chart. The interface used in some embodiments defaults to a ring chart showing five generations at a glance, comprising 63 individuals. The example illustrated in FIG. 1A includes 7 generations. In the example illustrated, each cell in the chart may be color-coded. In some embodiments, white indicates an unknown individual, a light shade of a color indicates a known ancestor with missing information, and a darker shade of a color indicates an individual for whom all desired work is completed.

Notably, as will be explained in more detail below, varying amounts of shading or texturing can be used to visually indicate varying amounts of work completed or remaining. For example, many computer systems allow 256 different color shades for a given color. Thus, some embodiments may have 256 different levels that could be illustrated. However, it should be appreciated that in some embodiments 256 points are far more than may be needed and thus, starker contrasts can be used by selecting color shades more distinct from each other. Further, embodiments may assign certain tasks with a higher value (such as tasks that are defined or determined to be more important, or tasks that are typically more difficult to perform) such that higher value tasks will cause more or less shading than lower value tasks. Additionally, while color shading has been discussed, it should be appreciated that other indications may be used. For example, certain elements may be displayed with varying prominence, such as by being displayed with varying 3D textures or the like. Example of this functionality will be discussed in more detail below.

Various interface elements, such as check boxes, radio buttons, drop-down elements, etc., can be used to allow the user some configuration over the criteria for considering a cell to be complete. For example, three checkboxes may be used to allow the user to specify that the interface should show one or more of 1) missing birth or death dates, 2) missing parent or spouse, or 3) missing ordinances (such as baptisms, marriages, etc.). Unchecking one or more boxes eliminates the need for that work to be considered in assessing the relative completion of work for a given individual. In the case where all boxes are unchecked, any known individual would, by definition, be considered complete. By checking one or more of the three boxes, the user can specify the completion criteria for individuals in the chart. One of the effects of this interface is that a user can see almost instantaneously where work needs to be done. Viewed from a gaming perspective, the interface invites the user to consider setting off on a quest to find the missing ancestors colored white, or to find more information about those shaded a light color. The dark shaded cells provide an immediate sense of accomplishment for the user as all cells in a graph become complete over time.

Embodiments may include functionality for providing additional information about an individual that may not be able to be provided within the constraints of a ring chart element of limited size. For example, embodiments may allow for additional windows or pop-ups to be displayed with additional information. For example, embodiments may be implemented such that hovering a mouse pointer over an element of the ring chart 102 reveals the names of the individual associated with the element in the ring chart, providing a simple way for the user to quickly build a mental model of the ancestors in the particular chart. Further, embodiments may be implemented where in such an example, clicking on any non-empty cell in the chart causes a mini-profile 106 to be displayed with summary information for that individual. The mini-profile 106 may include, for example, one or more of the person's name, gender, birth and death dates and places (if known), and a description of the work that is missing for that individual. In the illustrated example, name, birth date and place, death date, marriage date and place, and various ordinance dates are shown.

In some embodiments, the default view for a user is the ring chart view. This view can be accessed in a number of different ways, such as navigation links, tab selection, or other user interface element selection. For example, FIG. 1B illustrates an example where a ring chart 108 can be accessed by selecting an “Ancestors” tab 110.

In some embodiments, two other tabs provide two alternative views for an individual at the center node of a ring chart.

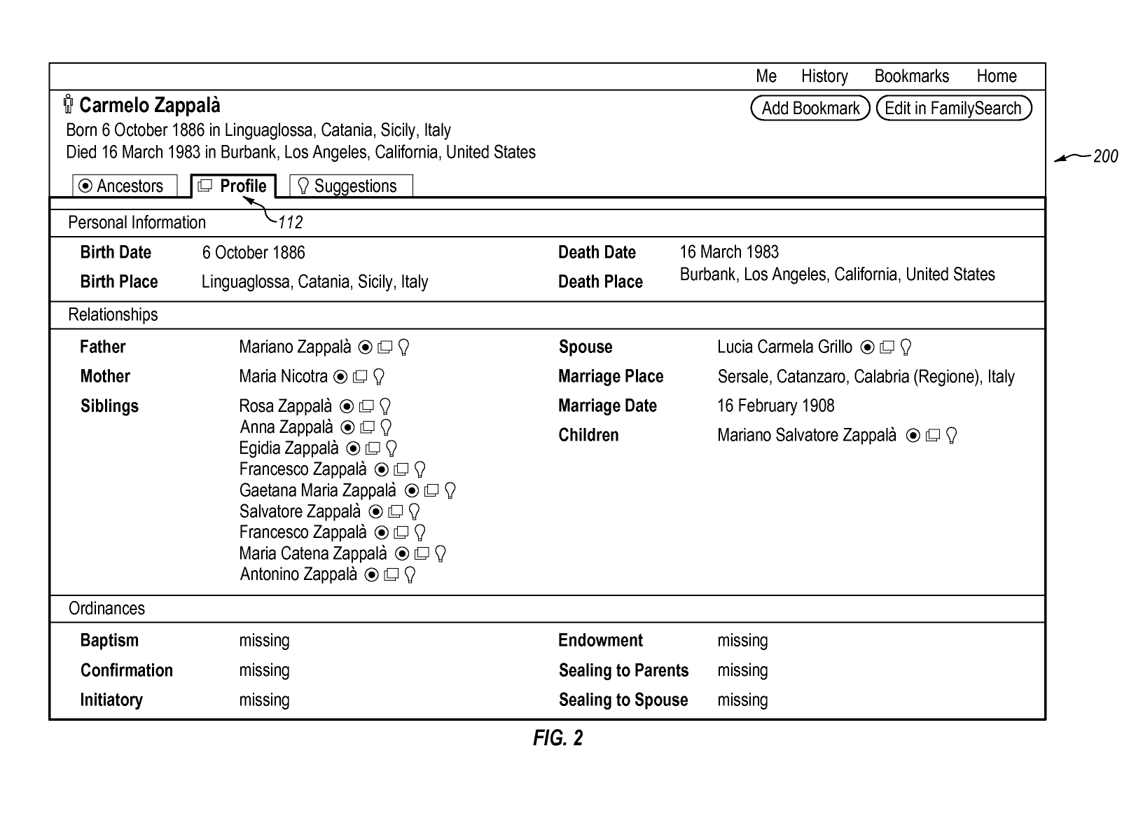

The first is a profile view 200 (see FIG. 2), which in the illustrated example can be displayed by selecting a profile tab 112. The profile view 200 provides detailed information from a database or service for the particular ancestor in the center of the ring chart. In some embodiments, the FamilySearch ancestral search tool database may be used to obtain the detailed information. The profile view 200 may also include an indication of incomplete fields tagged or highlighted. For example, the profile view may tag incomplete fields with an entry “missing”.

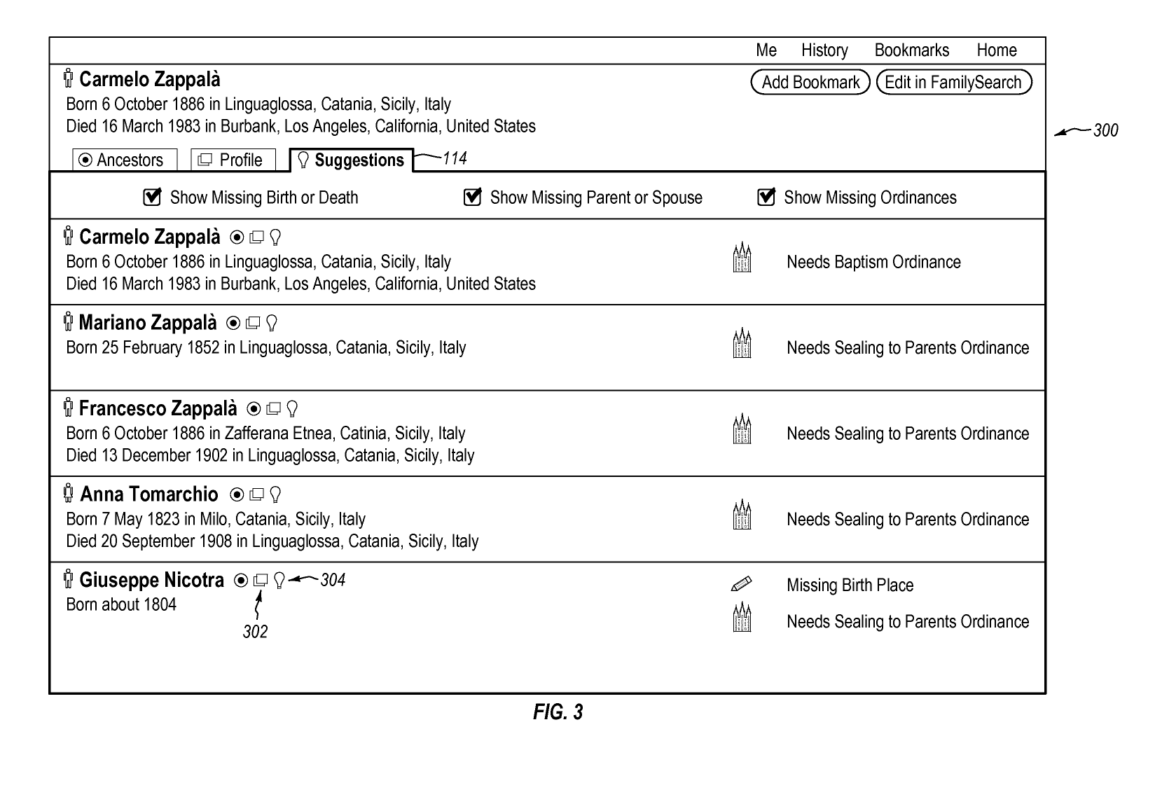

The second additional view is a suggestions view 300 (see FIG. 3), which in the illustrated example can be displayed by the user selecting the suggestions tab 114. The suggestions view 300 provides a list of suggested tasks associated with ancestors of the individual at the center of the chart. In one embodiment, the suggestions view 300 articulates tasks that relate to specific quests important to the user (helping guide the user toward completion of a quest) or relate to the completion of a particular task for an ancestor, consistent with the user's configured criteria of completeness.

As noted, the profile view 200 of the person at the center of the ring chart can be accessed by clicking the profile tab 112 below that person's name. However, some embodiments may be implemented where, for any individual whose name appears anywhere in the interface, whether in the ring chart of the ancestry view, the detailed information of the profile view 200, or the list of individuals in the suggestions view 300, a user interface element, such as a profile icon (e.g. icon 302 illustrated in FIG. 3) permits the user to make that person the central focus, and move to the profile view 200 for that person. In this manner, the interface permits easy navigation through parents, siblings, or children. In some embodiments, a history is maintained for all individuals who have been the focus of the console.

In a similar manner, the suggestions view 300 of the person at the center of the ring chart can be accessed by clicking on the suggestions tab 114, and a list of suggestions for any individual can be accessed by clicking a suggestions icon (such as icon 304 illustrated in FIG. 3) for an individual.

These interface components work in harmony to provide a console that provides a user with a big picture of the overall challenge at hand, a grasp of the ancestors not yet discovered, and a comprehension of the specific puzzles yet to be solved for a particular individual. The ring chart of the ancestors view helps the user to manage the sense of accomplishment and zero in on a particular individual of interest. The profile view for an individual identifies specific missing information, each of which can be viewed as a quest to perform or puzzle to solve.

Hence a context is established with a very short time investment, and at a very low cognitive investment on the part of the user. The suggestions view is valuable when a user either does not want to be bothered at all with the big picture, or simply trusts the system to manage the overall quest by simply suggesting the most proximal ancestor in need of work. For users who prefer the suggestions view as a method of navigating and contextualizing genealogy research, they arrive in their context as quickly as it takes them to select an individual from the list of suggestions and pull up their profile view to identify specific missing information. A user is thus enabled to dive immediately into the actual work of family history research with a contextual latency on the order of tens of seconds. The “threshold of thrashing” experienced by genealogists can thereby be reduced or eliminated. This may be particularly true, in the example illustrated, for the first 63 individuals within five generations of the user.

As noted above, some embodiments provide accesses to live data from a data service, such as FamilySearch. However, some embodiments may not provide the user with editing capabilities directly from a user interface provided by the embodiments. Rather, a user interface element, such a button or link, may redirect a user to an interface for the data service that enables the user to edit data in the data service directly. For example, a user selecting a button (such as the button 116) takes the user to a separate tab where they can use FamilySearch to edit and modify information in their family tree. The data input into the data service can then be used to update the data in the genealogical tool of the present invention.

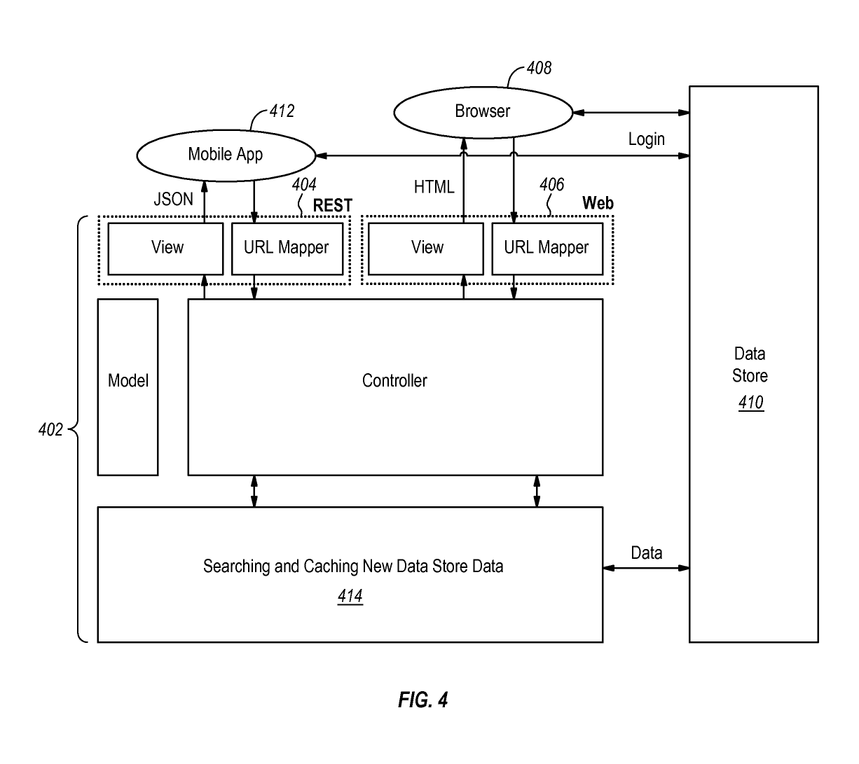

Referring now to FIG. 4, an example architecture is illustrated that may be used to implement some embodiments. Notably, while the preceding examples have focused on web-based application elements, mobile applications for handheld devices, such as phones, tablets, etc. may be used. For example, some embodiments may include so called “apps” for iOS devices available from Apple Corporation of Cupertino, Calif. and Android devices available from Google Corporation of Mountain View, Calif.

FIG. 4 illustrates a sever 402. In the illustrated example, the server is built using a Django web framework available from the Django Software Foundation. The server 402 employs a model-view-controller web development framework, with both a REST interface 404 and a web interface 406. In the illustrated examples, a browser 408 uses OAuth to login to the data store 410 (e.g., FamilySearch) whereas mobile applications 412 use HTTP authentication.

Embodiments may include a module 414 within the server 402 that provides high-level searching and caching of data from the data service 410. In some embodiments, this module 414 takes as input the starting ancestor, the number of generations to search, whether to include children of each family, and a search criteria. The search module 414 then accesses a data service 410 API to search the starting ancestor's pedigree, returning a list of all people in the tree, marked up with the information missing based on the search criteria. For example, the current search criteria may include:
Missing event. This marks a person who is missing a complete life event, such as birth or death. Some embodiments may use the criteria that each person must have either a complete birth event or a complete death event. However, embodiments of the server 402 also support the criteria that both events must be present, or can limit itself to just the birth or just the death event. To be complete, the event includes both a date and a place.
Missing family. This marks a person who is missing a parent, spouse, siblings, or children. Some embodiments may use the criteria that each person has both parents and a spouse in order to be complete.
Missing ordinances. This marks a person who is missing any ordinances. Ordinances are religious or other ceremonies performed for some individual. For example, ordinances may be baptisms, confirmations, marriages, etc. Additionally, this may include honors or ceremonies performed posthumously for an individual. The server 402 supports searching on individual ordinances or combinations of ordinances, whether performed in person or by proxy, so other embodiments may allow more targeted searches than simply on completion of all ordinances.

The server 402 also supports a descendancy search and complete traversal of a family graph.

Most genealogy interfaces present the user with a set of names displayed in a pedigree chart or family group sheet, after which the user may request information concerning a specific individual. In contrast, embodiments of the invention may be configured to deliver a graphic representation that includes all individuals within five (or some other selected or predetermined number) generations of the central person, as well as a readily discernible summary of work completed versus work yet to be performed for individuals in the chart. This can impose a significant level of complexity on the search module 414. Rather than simply requesting names and then fetching detailed information on demand, the search module 414 may perform detailed queries for every individual in the chart. In some embodiments, this searching can occur even before the chart is displayed to the user.

To accumulate this information, the search module 414 first reads the pedigree of an ancestor from the data store 410 to acquire a list of individuals. It then reads the detailed records of those individuals in batches in one or more HTTP requests. In some embodiments, the request may include a preselected number of batches. One example embodiment reads the detailed records of those individuals in batches of 10 in a single HTTP request, employing 10 threads at a time. Finally, the module 414 reads the relationship data for the first spouse in each relationship. This may be done in some embodiments by using 10 threads at a time. This design provides high throughput to read data from a remote server while also producing a timely visualization for the user.

A number of complexities are involved in determining whether an individual needs additional work. First, embodiments differentiate between deceased persons who lack relevant information, from living persons (who will, per force, lack death information). Following data store (e.g., FamilySearch) guidelines, embodiments identify an individual without death information as deceased if their birth date exceeds a predetermined threshold, such as more than 110 years ago, or if their marriage exceeds a certain threshold, such as more than 95 years ago. Conversely, a living individual is one who lacks death information, was born less than 110 years ago or married less than 95 years ago. Embodiments therefore refrain from pointing out the lack of spouse, children, or ordinances for living persons.

Of course, it's entirely common for a deceased individual to have been born less than 110 years ago, and to have never married or had children. Some embodiments mark this person as missing these family members. Other embodiments may provide functionality for users to indicate when a deceased person never married or had children.

Some embodiments may include links to existing genealogical services to help users find missing information and to provide research guidance. Some such services include Ancestry.com and the previously mentioned FamilySearch. Thus, embodiments may direct a user to products and systems that have strong expertise in certain areas of genealogy research to help users to find missing information.

Embodiments may include bookmarking functionality. For example, embodiments may include support for tagging and integration of notes and tags across the application. Tagging allows a user to attach meta information to a particular record, enabling advanced searching capabilities to be implemented that enhance the user's experience and increase researcher productivity.

While not illustrated here, some embodiments may include a descendants tab that graphically shows the descendants of an individual. In one embodiment, the descendancy view allows the user to see the relationship of a descendant in conjunction with that individual's ancestral context.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

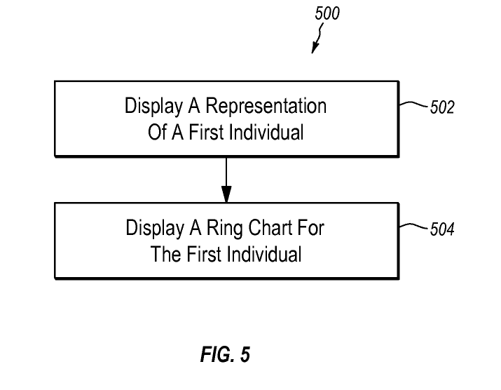

Referring now to FIG. 5, a method 500 is illustrated. The method 500 may be practiced in a computing environment and includes acts for presenting genealogical information. The method includes displaying a representation of a first individual (502). The method 500 further includes displaying a ring chart for the first individual (504). The ring chart comprises elements representing individuals with familial relationships to the first individual where rings in the ring chart represent generational relationships from the first individual. Displaying a ring chart according to the method 500 includes displaying the ring chart with visual coding. The visual coding indicates a level of completeness of research done for individuals represented in the ring chart.

The method 500 may be practiced where rings in the ring chart are generational rings each ring representing a generation level (either progeny or posterity) from the first individual. For example, in FIG. 1A, the ring 118 is the first generation of ancestor from the center node 104. The ring 120 is the second generation of ancestor from the center node 104. And so forth.

The method 500 may further include receiving user input selecting an element of the ring chart representing a second individual related to the first individual and as a result causing the second individual to become the focus of a ring chart where the rings of the ring chart represent familial relationships with the second individual. For example, a user may drag an individual from the ring chart 102 to the center node 104 of the ring chart 102, which causes the ring chart to be rearranged to represent generations of ancestors or decedents of the new individual in the center node 104.

The method 500 may further include receiving user input selecting an element of the ring chart representing an individual illustrated in the ring chart, and as a result, displaying a representation of genealogical research that has been done for the individual. For example, in the example illustrated in FIG. 1A, the mini-profile 106 may be displayed by hovering over or clicking on an individual. In some such embodiments, selecting an element of the ring chart representing an individual illustrated in the ring chart results in displaying a representation of genealogical research that has not been done for the individual. For example, a list of tasks to be performed may be provided. Alternatively, embodiments may annotate elements to show what has not been completed. An example of this is illustrated in FIG. 2, where certain elements are annotated to indicate missing information. The representation, may include, for example, a listing that includes items such as birth information, death information, marriage information, baptism information, or other religious or other ceremony information. The representation may be a full listing of information for an individual, or a summary listing of information for an individual. Embodiments may be configured such that a summary listing of information is configurable by a user. For example, a user may select what elements are important to the user. These elements then will be displayed or displayed with more prominence. In some embodiments, the representation does not replace the ring chart in the user's view. Rather, the representation may overlay the ring chart, be displayed to the side of the ring chart, or be displayed in some other fashion concurrently with the ring chart. In other embodiments, the representation may replace the ring chart as a visual focus for the user.

The method 500 may further include receiving user input selecting an element of the ring chart representing an individual illustrated in the ring chart, and as a result, displaying a representation of genealogical research that has not been done for the individual.

The method 500 may be practiced where the visual coding comprises color coding. For example, the color coding may include a heat map where hotter colors on the heat map indicate more research has been completed and cooler colors on the heat map indicate less research has been completed. Alternatively, the color coding may include a heat map where cooler colors on the heat map indicate more research has been completed and hotter colors on the heat map indicate less research has been completed. The color coding can be configured by a user. For example, user settings provided in a user interface may allow a user to select colors or shading and what those colors or shading represent.

The method 500 may be practiced where the visual coding comprises a represented height. For example, individual elements, such as the center node 104, or other nodes in the ring chart 102, may be represented to appear as if they have a three dimensional quality. This can be done for example, by using perspective rendering and other techniques. In some embodiments, a taller represented height indicates a greater level of completed research, and a shorter height indicates a lesser level of completed research. Alternatively, a taller represented height indicates a lesser level of completed research, and a shorter height indicates a greater level of completed research. Embodiments may be implemented where the represented height can be configured by the user by interaction with user interface elements in a user interface.

The method 500 may be practiced where the visual coding comprises a numerical representation. For example, a badge counter, percent complete, or other representation may be overlaid on an element of the ring chart for an individual. In some embodiments, a larger numerical value indicates a greater level of completed research, and a smaller numerical value indicates a lesser level of completed research. Alternatively, embodiments may be implemented where a larger numerical value indicates a lesser level of completed research, and a smaller numerical value indicates a greater level of completed research. Embodiments may be implemented where the numerical value can be configured by the user by interaction with user interface elements in a user interface.

Embodiments of the method 500 may be implemented to allow user configurability. For example, the method 500 may be practiced where research goals can be configured by the user. In particular, user interface elements may allow the user to select items that are important. Such items may include dates, locations, ordinances, etc. User configurability may allow a user to specify criteria of completeness. For example, embodiments may allow a user to specify what sub-items must be documented for an item to be complete, or what items must be documented for an individual to be complete. For example, for a birth item to be complete, a user may specify that both date and place need to be documented.

The method 500 may further include displaying for the user a history of individuals viewed by the user. For example, as a user navigates the ring chart 102, they may select or view certain individuals. The individuals selected can be included in a history list so that a user can view the individuals previously viewed. In some embodiments, the history of individuals is interactive, such that a user may select an individual from the history causing that individual to be selected and moved into focus (e.g. moved into the center node 104) on the ring chart.

Similarly, some embodiments may allow for user bookmarking. Thus, a set of bookmarks of individuals may be accessible to and configurable by the user. Illustratively, a user may select an individual and add a bookmark associated with the individual. The individual may then appear in a set of bookmarks from which the user can select later. The set of bookmarks is interactive, such that a user may select an individual from the bookmarks causing that individual to be selected and moved into focus (e.g. moved into the center node 104) on the ring chart.

The method 500 may further include providing a list of suggestions to the user. The list of suggestions may indicate suggested research activities for the user to perform. In some embodiments, the list of suggestions is automatically determined, consistent with and dependent upon the research goals indicated and/or configured by the user. Alternatively or additionally, the list of suggestions is automatically determined, consistent with and dependent upon the criteria of completeness specified and/or configured by the user.

The method 500 may be practiced where research notes can be created by the user. The research notes may relate to research goals. In some embodiments, the research notes can be associated with specific individuals. Some such embodiments may allow the research notes to be accessed in conjunction with accessing other information, such as information in a profile, for the user.

The method 500 may further include providing, to a user, specific recommendations concerning sources of potential answers to research questions relating to individuals. For example, embodiments may have knowledge about what types of information can be found from what sources. Embodiments may direct a user to certain records repositories, graveyards, research services, etc., depending on what information needs to be obtained by a user and system knowledge about what sources can provide what information.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as a collection of one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of presenting genealogical information, the method comprising:
displaying a representation of a first individual; and
displaying a ring chart for the first individual, wherein the ring chart comprises elements representing individuals with familial relationships to the first individual in a ring chart fashion, and wherein displaying a ring chart comprises displaying the ring chart with visual coding, wherein the visual coding indicates a level of completeness of research done for individuals represented in the ring chart.

2. The method of claim 1, wherein rings in the ring chart are generational rings each ring representing a generation level from the first individual.

3. The method of claim 1, further comprising receiving user input selecting an element of the ring chart representing a second individual related to the first individual and as a result causing the second individual to become the focus of a ring chart where the rings of the ring chart represent familial relationships with the second individual.

4. The method of claim 1, further comprising receiving user input selecting an element of the ring chart representing an individual illustrated in the ring chart, and as a result, displaying a representation of genealogical research that has been done for the individual.

5. The method of claim 4, wherein the selecting an element of the ring chart representing an individual illustrated in the ring chart results in displaying a representation of genealogical research that has not been done for the individual.

6. The method of claim 4, wherein the representation comprises a listing that includes at least one of birth information, death information, marriage information, baptism information, or other religious ceremony information.

7. The method of claim 6, wherein the representation is a summary listing of information for an individual, and wherein the set of elements displayed in the summary listing is configurable by a user.

8. The method of claim 4, wherein the representation does not replace the ring chart in the user's view but hovers over or is displayed to the side of the ring chart.

9. The method of claim 4, wherein the representation replaces the ring chart as the visual focus of the application.

10. The method of claim 1, further comprising receiving user input selecting an element of the ring chart representing an individual illustrated in the ring chart, and as a result, displaying a representation of genealogical research that has not been done for the individual.

11. The method of claim 1, wherein the visual coding comprises color coding.

12. The method of claim 11, wherein the color coding comprises a heat map where hotter colors on the heat map indicate more research has been completed and cooler colors on the heat map indicate less research has been completed.

13. The method of claim 11, wherein the color coding comprises a heat map where cooler colors on the heat map indicate more research has been completed and hotter colors on the heat map indicate less research has been completed.

14. The method of claim 11, wherein the color coding can be configured by a user.

15. The method of claim 1, wherein the visual coding comprises a represented height.

16. The method of claim 15, wherein a taller represented height indicates a greater level of completed research, and a shorter height indicates a lesser level of completed research.

17. The method of claim 15, wherein a taller represented height indicates a lesser level of completed research, and a shorter height indicates a greater level of completed research.

18. The method of claim 15, wherein the represented height can be configured by the user.

19. The method of claim 1, wherein the visual coding comprises a numerical representation.

20. The method of claim 19, wherein a larger numerical value indicates a greater level of completed research, and a smaller numerical value indicates a lesser level of completed research.

21. The method of claim 19, wherein a larger numerical value indicates a lesser level of completed research, and a smaller numerical value indicates a greater level of completed research.

22. The method of claim 19, wherein the numerical value can be configured by the user.

23. The method of claim 1, wherein research goals can be configured by the user.

24. The method of claim 1, wherein the criteria for completeness for one or more quests is configured by a user.

25. The method of claim 1, wherein the criteria for completeness for one or more individuals in the chart can be configured by a user.

26. The method of claim 1, further comprising providing a history to a user of interactions with data elements related to the first individual.

27. The method of claim 26, further comprising receiving user interaction with the history of first individual, such that a user may select an individual from the history causing that individual to be selected and displayed as a first individual.

28. The method of claim 1, further comprising providing a configurable set of bookmarks of individuals to a user.

29. The method of claim 28, wherein the set of bookmarks is interactive, the method further comprising receiving a selection by a user of an individual from the set of bookmarks causing that individual to be selected as a first individual.

30. The method of claim 1, further comprising providing a list of suggestions to a user.

31. The method of claim 30, wherein the list of suggestions is automatically determined, consistent with and dependent upon the research goals that are configurable by the user.

32. The method of claim 31, wherein the list of suggestions is automatically determined, consistent with and dependent upon the criteria of completeness that are configurable by the user.

33. The method of claim 1, further comprising providing to a user specific recommendations concerning sources of potential answers to research questions relating to individuals.
